(19) United States
(12) Patent Application Publication
(10) Pub. No.: US 2026/0133800 A1
(43) Pub. Date: May 14, 2026

(54) METHOD AND APPARATUS FOR CONTROLLING INPUT/OUTPUT OPERATION OF VECTOR PROCESSOR IN MIXED PRECISION ENVIRONMENT

(71) Applicant: SEOUL NATIONAL UNIVERSITY R&DB FOUNDATION, Seoul (KR)

(72) Inventors: Hyuk-Jae LEE, Seoul (KR); Jongchan KIM, Seoul (KR)

(73) Assignee: SEOUL NATIONAL UNIVERSITY R&DB FOUNDATION, Seoul (KR)

(21) Appl. No.: 19/285,382

(22) Filed: Jul. 30, 2025

(30) Foreign Application Priority Data
Nov. 13, 2024 (KR) 10-2024-0161039
Jan. 15, 2025 (KR) 10-2025-0006333

(51) Int. Cl. G06F 9/30

(52) U.S. Cl. CPC G06F 9/30098; G06F 9/30036; G06F 9/30043

(57) ABSTRACT

A The present invention relates to a technique for controlling input/output operation of a vector processor, which is designed to optimize vector operation in a mixed precision environment, and to a technique for maximizing data processing performance while minimizing waste of operation resources by improving the data conversion process between the memory and the vector processor.

### CROSS REFERENCE TO RELATED APPLICATION

The present application claims the benefit of Korean Patent No. 10-2024-0161039 and Korean Patent No. 10-2025-0006333 filed in the Korean Intellectual Property Office on Nov. 13, 2024 and Jan. 15, 2025, the entire contents of which are incorporated herein by reference.

### BACKGROUND OF THE INVENTION

### Field of the Invention

The present invention relates to a technique for controlling input/output operation of a vector processor, which is designed to optimize vector operation in a mixed precision environment, and to a technique for maximizing data processing performance while minimizing waste of operation resources by improving the data conversion process between the memory and the vector processor.

Meanwhile, the present invention is sponsored by the national research and development project described below.
Project ID: 2710008363
Project Number: II201305
Name of Ministry: Ministry of Science and ICT
Name of Project Management (Specialized) Agency: Institute of Information & communications Technology Planning & Evaluation
Name of Research Program: Development (Design) of Next-Generation Intelligence Semiconductor Technology
Name of Research Project: Development of 2,000 TFLOPS-Class Server Artificial Intelligence Deep Learning Processor and Module
Name of Project Execution Agency: Rebellions (formerly Sapeon Korea)
Research Period: 2025 Jan. 01˜2025 Dec. 31

### Background of the Related Art

With rapid development of deep learning techniques, hardware requirements for efficient performance of large-scale data processing and complex operation are increasing. In particular, vector operations frequently used in deep learning operation perform an important role in maximizing operation speed through parallel processing of data. At this point, vector operations are performed in a way of repeating a process of transferring a large amount of data from memory to a processing unit and storing results thereof back into the memory. In this process, balancing the memory space and operation accuracy is emerging as a key task for vector data.

In the existing techniques, a method of utilizing hardware such as a high-performance GPU to support large-scale parallel operation or supporting vector operation by extending SIMD instructions to a CPU has been used frequently. In particular, systems that combine a vector operation unit and a high-speed memory interface have been developed to process large-scale data in the learning and inference process of a deep learning model. These systems have been successfully applied in various fields such as image processing, voice recognition, and natural language processing, and made an important technical advancement.

However, the existing techniques have some limitations. Due to the nature of deep learning operation, a considerable part of data has a sparse distribution (0 or an invalid value in operation), and this actually reduces the ratio of valid operations. As the existing techniques process all data equally in the data distribution like this, resources are consumed even for invalid operations. In particular, when a fixed precision data format is used, excessive memory usage and energy consumption may occur in data transmission between the memory and operation units. Accordingly, both operation efficiency and energy efficiency are lowered, and this problem is more prominent in applications that require large-scale data processing.

To solve these problems, it is required to develop a technique that can efficiently use resources by selectively performing only valid operations considering the characteristics of sparse data. In particular, it is required to develop a new approach that may lower unnecessary waste of resources in data transmission and operation between a memory and operation units by utilizing mixed precision, and improve performance and energy efficiency at the same time.

### Patent Document

Korean Laid-opened Patent No. 10-2024-0136078

### Non-patent Document

J. Deng, W. Dong, R. Socher, L.-J. Li, Kai Li and Li Fei-Fei, “ImageNet: A large-scale hierarchical image database,” 2009 IEEE Conference on Computer Vision and Pattern Recognition, Miami, FL, USA, 2009, pp. 248-255, doi: 10.1109/CVPR.2009.5206848.

### SUMMARY OF THE INVENTION

An object of the present invention is to maximize the efficiency of memory and operation resources through a hardware structure that can perform only necessary operations by determining valid data considering the characteristics of sparse data in a mixed precision environment and selectively processing only valid data.

Through this, the present invention proposes a method of lowering waste of resources while maintaining operation accuracy by optimizing a data format conversion process in a mixed precision environment.

Furthermore, another object of the present invention is to contribute to achieving a balance between performance and energy efficiency in a deep learning workload that requires large-scale parallel operation.

Meanwhile, the technical problems of the present invention are not limited to the technical problems mentioned above, and unmentioned other technical problems can be clearly understood by those skilled in the art from the following descriptions.

To accomplish the above objects, according to one aspect of the present invention, there is provided a method performed by a vector processor input/output control apparatus operated by a processor, the method comprising: an operation of loading a first data configured of elements of N-bit format onto a lower memory corresponding to a vector register for performing a vector operation; an operation of classifying the elements of the first data into one or more groups, and extracting a valid element corresponding to valid data from each group on the basis of magnitude and similarity of element values of the elements of each group; an operation of loading a second data obtained by converting the valid element into an element of 2N-bit format onto the vector register, and performing a vector operation; and an operation of converting a result of the vector operation into a third data configured of elements of N-bit format with reference to an index and similarity of the valid element, and storing the third data in the lower memory.

In addition, the operation of extracting a valid element may include an operation of classifying the elements into halves in order of indexes of the elements included in the first data, and creating two groups.

In addition, the operation of extracting a valid element may include an operation of determining an element having a larger element value according to preset criteria by one-to-one comparing the element values of the elements belonging to each group.

In addition, when both an element value of an element with index A and an element value of an element with index B are ‘0’ in determining an element having a larger element value among the element with index A and the element with index B (A is an index smaller than B), the operation of determining an element having a larger element value may include an operation of determining the element with index A the larger.

In addition, when one among two values of an element value of an element with index A and an element value of an element with index B is ‘0’ in determining an element having a larger element value among the element with index A and the element with index B (A is an index smaller than B), the operation of determining an element having a larger element value may include an operation of determining an element having a value other than ‘0’ the larger.

In addition, when both an element value of an element with index A and an element value of an element with index B are not ‘0’ in determining an element having a larger element value among the element with index A and the element with index B (A is an index smaller than B), the operation of determining an element having a larger element value may include an operation of determining an element having a larger value by comparing exponent bits and mantissa bits excluding a sign bit of a floating-point number of each element value.

In addition, the operation of extracting a valid element may include an operation of extracting valid elements as many as half of the number of elements belonging to each group, and storing index information of the extracted valid elements in a first register.

In addition, the operation of storing the third data in the lower memory may include an operation of generating the third data by inserting a value, which is obtained by converting a result of the vector operation performed on the valid element in an N-bit format, at a position of the element value of the index information extracted as a valid element among the elements of each group with reference to the first register.

In addition, the operation of extracting a valid element may include an operation of determining similar elements having similarity between element values according to preset criteria by comparing element values of elements having adjacent index information among the elements belonging to each group.

In addition, when it is determined that N−1 or more bits of the most significant bits (MSB), including a sign bit of an element value of an element with index A and an element value of an element with index B, among total N bits are the same in determining similarity between an element with index A and an element with index B (A is an index smaller than B) having adjacent index information, the operation of determining similar elements may include an operation of determining that the element with index A and the element with index B are similar.

In addition, the operation of extracting a valid element may include an operation of adding a bit flag to a similar element pair specifying the element with index A and the element with index B determined to have similarity, and storing the similar element pair in a second register.

In addition, when a first element, which is any one among the similar element pair included in each group, corresponds to a valid element and a vector operation is performed with reference to the second register, the operation of storing the third data in the lower memory may include an operation of generating the third data by inserting a value the same as an element value of the first element, on which a vector operation is performed, at a position of the element value of a second element, which is the other one on which the vector operation is not performed.

In addition, the operation of extracting a valid element may include an operation of comparing a magnitude and similarity of element values between elements on the basis of a comparator configured to receive two element values, output an element value of a larger magnitude, and output whether there is a similarity between the elements.

In addition, when the first data has 2M elements and each group has M elements, and a pattern is determined for a result of comparing magnitude values of elements having adjacent index information among the elements belonging to each group on the basis of M−1 comparators that compare the magnitude and similarity of element values between elements having adjacent index information among the elements belonging to each group, the operation of extracting a valid element may include an operation of extracting the valid element on the basis of multiplexers that determine M/2 elements, which are as many as half of M elements included in each group, by using a combination of any two elements among the elements included in each group as an input, and generating a selection signal set in advance on the basis of the pattern.

In addition, when both an element value of an element with index A and an element value of an element with index B are ‘0’ in determining an element having a larger element value among the element with index A and the element with index B (A is an index smaller than B), the comparator may determine the element with index A the larger.

In addition, when one among two values of an element value of an element with index A and an element value of an element with index B is ‘0’ in determining an element having a larger element value among the element with index A and the element with index B (A is an index smaller than B), the comparator may determine an element having a value other than ‘0’ the larger.

In addition, when both an element value of an element with index A and an element value of an element with index B are not ‘0’ in determining an element having a larger element value among the element with index A and the element with index B (A is an index smaller than B), the comparator may determine an element having a larger value by comparing exponent bits and mantissa bits excluding a sign bit of a floating-point number of each element value.

In addition, when it is determined that N−1 or more bits of the most significant bits (MSB), including a sign bit of an element value of an element with index A and an element value of an element with index B, among total N bits are the same in determining similarity between an element with index A and an element with index B (A is an index smaller than B) having adjacent index information, the comparator may determine that the element with index A and the element with index B are similar.

A vector processor input/output control apparatus according to an embodiment may comprise: a memory containing instructions; and a processor for performing a predetermined operation on the basis of the instructions, wherein the operation of the processor includes: an operation of loading a first data configured of elements of N-bit format onto a lower memory corresponding to a vector register for performing a vector operation; an operation of classifying the elements of the first data into one or more groups, and extracting a valid element corresponding to valid data from each group on the basis of magnitude and similarity of element values of the elements of each group; an operation of loading a second data obtained by converting the valid element into an element of 2N-bit format onto the vector register, and performing a vector operation; and an operation of converting a result of the vector operation into a third data configured of elements of N-bit format with reference to an index and similarity of the valid element, and storing the third data in the lower memory.

A computer program stored in a non-transitory computer-readable recording medium according to an embodiment may include instructions for performing, when the computer program is executed on at least one processor, an operation of loading a first data configured of elements of N-bit format onto a lower memory corresponding to a vector register for performing a vector operation; an operation of classifying the elements of the first data into one or more groups, and extracting a valid element corresponding to valid data from each group on the basis of magnitude and similarity of element values of the elements of each group; an operation of loading a second data obtained by converting the valid element into an element of 2N-bit format onto the vector register, and performing a vector operation; and an operation of converting a result of the vector operation into a third data configured of elements of N-bit format with reference to an index and similarity of the valid element, and storing the third data in the lower memory, performed by the processor.

### BRIEF DESCRIPTION OF THE DRAWINGS

FIG. 1 is a view showing the configuration of a vector processor input/output control apparatus according to an embodiment.

FIG. 2 is a conceptual view showing the difference between the data processing processes of an existing technique and the present invention when data on a lower memory is loaded onto a vector register.

FIG. 3 is a flowchart illustrating the steps of the operation performed by a vector processor input/output control apparatus according to an embodiment.

FIG. 4 is an exemplary view for explaining the structure of a comparator implementing the operation of step S1020 according to an embodiment.

FIG. 5 is an exemplary view for explaining a hardware structure including comparators and multiplexers implementing the operation of step S1020 according to an embodiment.

FIG. 6 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 1, 1, 2’.

FIG. 7 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 0, 2, 2’.

FIG. 8 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 0, 1, 3’.

FIG. 9 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 0, 2, 2’.

FIG. 10 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 1, 2, 2’.

FIG. 11 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 1, 1, 3’.

FIG. 12 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 1, 2, 2’.

FIG. 13 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 1, 2, 3’.

FIG. 14 is an exemplary view for explaining an operation of extracting two valid elements among four elements belonging to a specific group, and storing and utilizing similar elements that have not been extracted as valid elements in a second register.

FIG. 15 is a performance graph showing the ratio of improvement in execution time by the size of input images by applying an embodiment of the present invention.

### DETAILED DESCRIPTION OF THE PREFERRED EMBODIMENT

Details of the objects and technical configurations of the present invention and operational effects according thereto will be more clearly understood by the following detailed description based on the drawings attached in the specification of the present invention. An embodiment according to the present invention will be described in detail with reference to the accompanying drawings.

The embodiments disclosed in this specification should not be construed or used as limiting the scope of the present invention. For those skilled in the art, it is natural that the description including the embodiments of the present specification have various applications. Accordingly, any embodiments described in the detailed description of the present invention are illustrative for better describing of the present invention, and are not intended to limit the scope of the present invention to the embodiments.

The functional blocks shown in the drawings and described below are merely examples of possible implementations. Other functional blocks may be used in other implementations without departing from the spirit and scope of the detailed description. In addition, although one or more functional blocks of the present invention are expressed as separate blocks, one or more of the functional blocks of the present invention may be combinations of various hardware and software configurations that perform the same function.

In addition, the expressions including certain components are expressions of “open type” and only refer to existence of corresponding components, and should not be construed as excluding additional components.

Furthermore, when a certain component is referred to as being “connected” or “coupled” to another component, it may be directly connected or coupled to another component, but it should be understood that other components may exist in between.

Hereinafter, various embodiments of the present invention will be described with reference to the accompanying drawings. However, it should be understood that this is not intended to limit the present invention to specific embodiments, but to include various modifications, equivalents, and/or alternatives of the embodiments of the present invention.

The present invention proposes a vector processor input/output control apparatus 100 that implements a technique for maximizing data processing performance while minimizing waste of operation resources by improving the data conversion process between a memory and a vector processor in a mixed precision environment.

Hereinafter, the configuration of the vector processor input/output control apparatus 100 of the present invention and the operation of each configuration will be described.

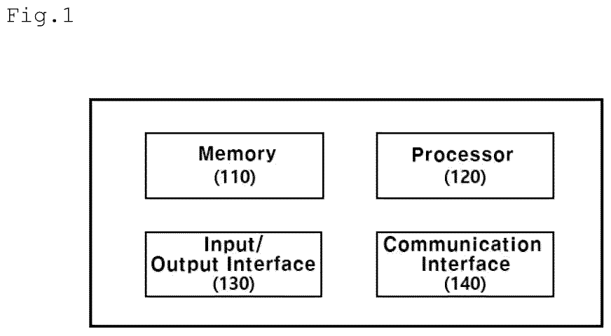

FIG. 1 is a view showing the configuration of a vector processor input/output control apparatus 100 (hereinafter, referred to as an ‘apparatus 100’) according to an embodiment.

Referring to FIG. 1, the apparatus 100 according to an embodiment may each include a memory 110, a processor 120, an input/output interface 130, and a communication interface 140.

The memory 110 performs a function of storing or reading data related to the operation of the apparatus 100, and may store parameters, data sets, intermediate results of operations, and the like needed for vector operation. For example, the memory 110 may include various storage devices such as DRAM, SRAM, or flash memory, and may be configured to efficiently manage format data such as FP8 or FP16 in a mixed precision environment. In addition, the memory 110 may store instructions that may perform operation of the processor 120.

The processor 120 is an operation device that loads data from the memory 110 and performs vector operation on the basis of the data. The processor 120 may execute instructions stored in the memory 110. The processor 120 may include a central processing unit (CPU) and a vector processor optimized for large-scale parallel operation and deep learning operation. The operation of the apparatus 100 according to the embodiment of this document may be understood as an operation performed by the processor 120.

According to an embodiment of the present invention, the vector processor includes a vector register and an operation unit, and may maximize operation efficiency by determining validity of sparse data and selectively processing only valid data. The vector processor may include a data format converter that supports a mixed precision environment and performs format conversion between 8-bit data and 16-bit data.

The input/output interface 130 may include a hardware interface or a software interface for inputting or outputting information.

The communication interface 140 allows transmission and reception of information through a communication network. To this end, the communication interface 140 may include a wireless communication module or a wired communication module.

The apparatus 100 may be implemented as various forms of devices that can perform operations through the processor 120 and transmit and receive information through a network. For example, although the device may be implemented in the form of a server, a computer device, a portable communication device, a smart phone, a portable multimedia device, a laptop computer, a tablet PC, or the like, it is not limited to these examples.

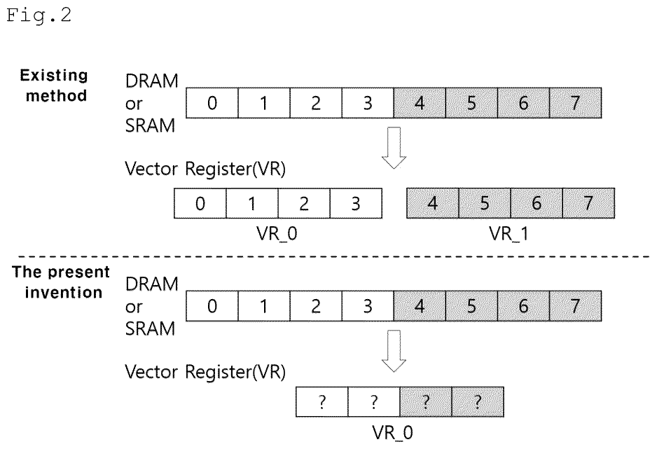

Hereinafter, the differences between the present invention implemented by the apparatus 100 described above and existing techniques are explained with reference to FIG. 2.

FIG. 2 is a conceptual view showing the difference between the data processing processes of an existing technique and the present invention when data on a lower memory is loaded onto a vector register.

Referring to the upper part of FIG. 2, the existing technique operates in a way of processing all data in the same manner and storing the data in the vector registers when loading data from a lower memory such as DRAM or SRAM onto vector registers. For example, when the data stored in the lower memory is [0, 1, 2, 3, 4, 5, 6, 7] as shown in the upper part of FIG. 2, the data is sequentially divided and loaded onto the vector registers VR_0 and VR_1. Since validity of the data is not considered in this process, even unnecessary data (e.g., 0 or invalid values) are loaded, and this results in waste of operation resources.

Referring to the lower part of FIG. 2, the present invention operates in a way of determining validity of data before loading the data from the lower memory onto the vector register and selectively loading only valid values. For example, as shown in the lower part of FIG. 2, only valid values among data [0, 1, 2, 3, 4, 5, 6, 7] of the lower memory are selected and loaded onto the vector register VR_0, and invalid data is excluded in the loading process.

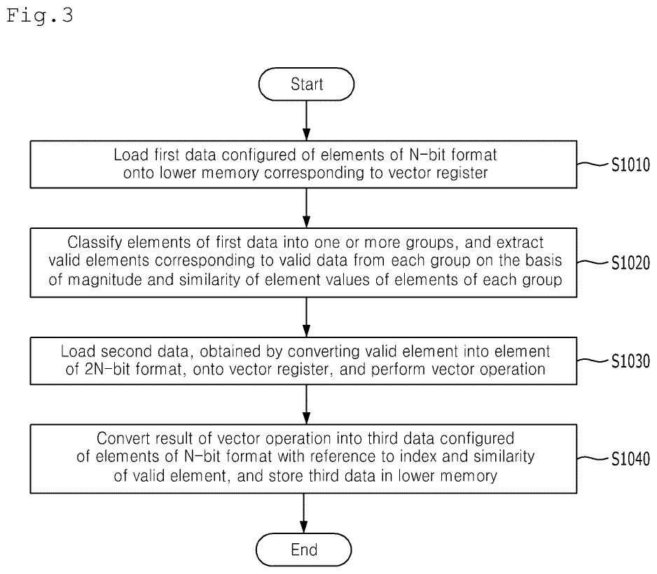

Accordingly, the present invention may improve performance and efficiency simultaneously in a large-scale deep learning operation and a sparse data processing environment by improving the inefficient data processing method of the existing techniques. The specific operation of the present invention for achieving this will be described with reference to FIG. 3.

FIG. 3 is a flowchart illustrating the operation performed by the apparatus 100 according to an embodiment. The operation of the apparatus 100 according to the embodiment of FIG. 3 may be understood as an operation performed by the processor 120.

The steps disclosed in FIG. 3 are only a preferred embodiment for achieving the objects of the present invention, and some steps may be added or deleted as needed, and any one step may be included and performed in another step. The order of each operation disclosed in FIG. 3 is only an order arranged for convenience of understanding, and this order is not limited to a time-series order, and the order may be changed to perform the operation in a different way according to the choice of a designer.

Referring to FIG. 3, at step S1010, the apparatus 100 may load a first data configured of elements of N-bit format (N is a natural number, for example, 8 bits) onto a lower memory corresponding to a vector register for performing a vector operation. For example, the apparatus 100 may read data from a non-volatile memory (for example, an HDD, an SDD, etc.) and load the data onto a lower memory (for example, DRAM, SRAM, etc.) corresponding to the vector register. At this point, each element of N-bit format configuring the first data may include a unique index number and an element value. Here, the index number indicates the order of each element and is referenced when validity of data is determined or an operation result is stored in the steps thereafter. The first data may go through a data format conversion process before it is transferred to a vector register for a vector operation in the steps thereafter.

At step S1020, the apparatus 100 may classify the elements of the first data into one or more groups, and extract valid elements corresponding to valid data from each group on the basis of the magnitude and similarity of the element values of the elements of each group.

For example, the apparatus 100 may classify the elements into halves in order of the indexes of the elements included in the first data and create two groups. For example, when the indexes of the elements included in the first data are configured of eight 8-bit elements assigned with a value between 0 and 7, elements with an index between 0 and 3 may be classified into a first group, and elements with an index between 4 and 7 may be classified into a second group.

For example, the apparatus 100 may determine an element having a larger element value according to preset criteria by one-to-one comparing the element values of the elements belonging to each group.

In the examples of the preset criteria described below, when indexes of any two elements to be compared one-to-one in each group are A and B, it is assumed that index A is an index with a number smaller than that of index B. Examples of the preset criteria are as described below.

According to the preset criteria, when both the element value of an element with index A and the element value of an element with index B are ‘0’ in determining an element having a larger element value among the element with index A and the element with index B, the apparatus 100 may determine that the element with index A is the larger.

According to the preset criteria, when one of two values among the element value of an element with index A and the element value of an element with index B is ‘0’ in determining an element having a larger element value among the element with index A and the element with index B, the apparatus 100 may determine that the element having a value other than ‘0’ is the larger.

According to the preset criteria, when both the element value of an element with index A and the element value of an element with index B are not ‘0’ in determining an element having a larger element value among the element with index A and the element with index B, the apparatus 100 may determine an element having a larger value by comparing the exponent bits and the mantissa bits excluding the sign bit of the floating-point number of each element value.

Accordingly, the apparatus 100 may extract valid elements as many as half of the number of elements belonging to each group, and store index information of the extracted valid elements in a first register. For example, the first register may be a register included in the lower memory, and the index information included in the first register is information for tracking the location in the original memory or the vector register where the extracted valid elements are stored, and this makes it easy to refer to data and store results in a vector operation process.

Meanwhile, an example of actual values for comparing element values of elements according to preset criteria will be separately described after the description of the overall operation of FIG. 3 is completed.

For example, the apparatus 100 may determine similar elements having similarity between element values according to preset criteria by comparing element values of elements having adjacent index information among the elements belonging to each group.

In the examples of the preset criteria described below, when indexes of any two elements to be compared one-to-one in each group are A and B, it is assumed that index A and index B are adjacent indexes (e.g., indexes 0 and 1, or indexes 3 and 4, etc.), and index A is an index with a number smaller than that of index B. Examples of the preset criteria are as described below.

According to the preset criteria, the apparatus 100 may compare the element value of an element with index A with the element value of an element with index B to determine the similarity between the element with index A and the element with index B adjacent to each other. At this point, the apparatus 100 may determine that the element with index A and the element with index B are similar when N−1 or more bits of the most significant bits (MSB), including the sign bit, among the total N bits of each element value are the same.

Accordingly, the apparatus 100 may store index information specifying similar elements in the second register. For example, the second register may be a register included in the lower memory, and the apparatus 100 may register indexes A and B determined to have similarity as a similar element pair, and store in the second register that the elements of indexes A and B are a similar element pair. For example, the apparatus 100 may store information on the similar element pair in the second register as a bit flag (e.g., additionally map bit ‘1’ to index information corresponding to similar element) or in the form of a table (e.g., map ‘1’ to a matrix value corresponding to similar element in a matrix in which rows and columns are configured of indexes).

Determination of similarity like this reduces duplicate operation of data and maintains accuracy of data by performing a vector operation using only a representative value extracted through comparison of an element with index A and an element with index B corresponding to similar elements in the steps described below, and applying a result of calculating the representative value to the other element of the similar element pair.

Meanwhile, an example of actual values for comparing similarity of elements according to preset criteria and storing a bit flag in the second register will be separately described after the description of the overall operation of FIG. 3 is completed.

At step S1030, the apparatus 100 may convert the extracted valid element into a second data configured of elements of 2N-bit format (N is a natural number, for example, 16 bits), load the second data onto a vector register, and perform a vector operation. For example, the apparatus 100 may convert the N-bit format valid element extracted at step S1020 into a 2N-bit format (for example, 8 bits—>16 bits) by utilizing a data format converter. At this point, the vector operation may perform various mathematical or logical operations on the converted second data.

At step S1040, the apparatus 100 may convert a result of the vector operation into a third data configured of elements of N-bit format with reference to the index and similarity of the valid element, and store the third data in the lower memory.

For example, the apparatus 100 may generate a third data by inserting a value, which is obtained by converting a result of the vector operation performed on the valid element in an N-bit format, at the position of the element value of the index information extracted as a valid element among the elements of each group with reference to the first register. In this process, the first register performs a function of tracking the memory address where each element is originally located on the basis of the index information of the valid element. Accordingly, the apparatus 100 may generate the third data by converting a 2N-bit format result generated through a vector operation into an N-bit format at step S1030 and storing the value at the memory address where each valid element is originally located on the basis of the index information of the valid element stored in the first register. In this way, the apparatus 100 may secure both the integrity and efficiency of data in the process of storing data in the lower memory by generating the third data in a way of accurately mapping the result of vector operation on the basis of the index information of the valid element.

For example, when a first element of any one among the similar element pair included in each group corresponds to a valid element and a vector operation is performed with reference to the second register, the apparatus 100 may generate a third data by inserting a value the same as the element value of the first element, on which a vector operation is performed, at the position of the element value of the second element, which is the other one on which the vector operation is not performed. This process may secure both the integrity and efficiency of data in the process of storing data in the lower memory by performing a vector operation using only the representative value extracted through comparison of an element with index A and an element with index B corresponding to similar elements and applying the operation result of the representative value to the other element of the pair of similar elements.

Hereinafter, the hardware configuration for implementing step S1020 will be described.

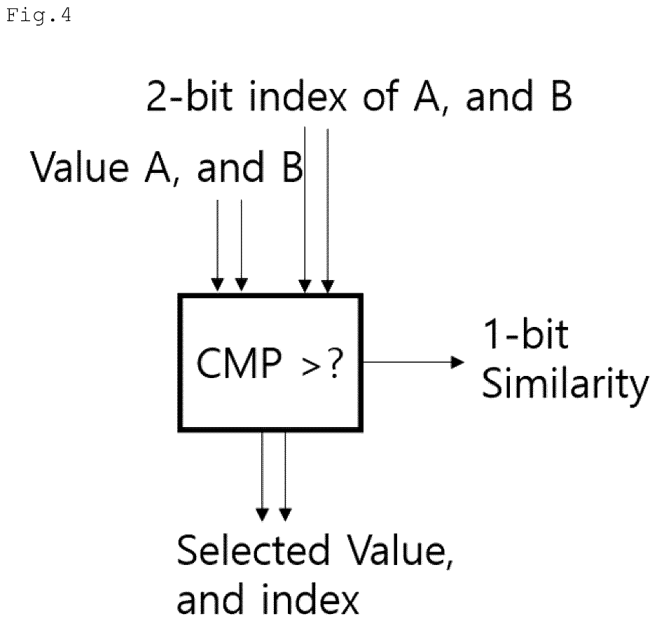

FIG. 4 is an exemplary view for explaining the structure of a comparator implementing the operation of step S1020 according to an embodiment.

Referring to FIG. 4, the processor 120 may include a comparator configured to receive two element values among the elements included in a specific group, output an element value determined to be the larger, and determine and output whether there is a similarity between the elements.

For example, the comparator may be designed as a configuration that determines, when both the element value of an element with index A and the element value of an element with index B are ‘0’ in determining an element having a larger element value among the element with index A and the element with index B (A is an index smaller than B), the element with index A the larger.

For example, the comparator may be designed as a configuration that determines, when the value of one among the element value of an element with index A and the element value of an element with index B is ‘0’ in determining an element having a larger element value among the element with index A and the element with index B (A is an index smaller than B), an element having a value other than ‘0’ the larger.

For example, the comparator may be designed as a configuration that determines, when both the element value of an element with index A and the element value of an element with index B are not ‘0’ in determining an element having a larger element value among the element with index A and the element with index B (A is an index smaller than B), an element having a larger value by comparing the exponent bits and the mantissa bits excluding the sign bit of the floating-point number of each element value.

For example, the comparator may be designed as a configuration that determines, in determining similarity between an element with index A and an element with index B (A is an index smaller than B) having adjacent index information, that the element with index A and the element with index B are similar when it is determined that N−1 or more bits of the most significant bits (MSB), including the sign bits of the element value of an element with index A and the element value of an element with index B, among the total N bits are the same.

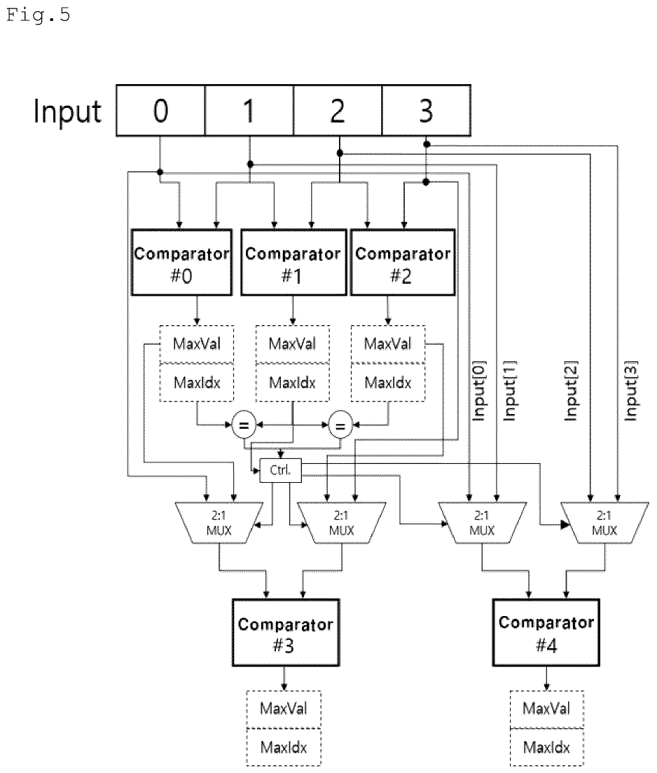

FIG. 5 is an exemplary view for explaining a hardware structure including comparators and multiplexers implementing the operation of step S1020 according to an embodiment.

Specifically, FIG. 5 is a view illustrating a hardware configuration that extracts valid elements from a group including M (e.g., 4) elements having indexes of 0, 1, 2, and 3 when the first data is as many as 2M (M is a natural number, e.g., M=4, 8) classified into two groups.

Referring to FIG. 5, the processor 120 may compare the magnitude values of elements having adjacent index information among the elements belonging to each group on the basis of M−1 (e.g., 3 as M=4) comparators (e.g., comparator #0, comparator #1, comparator #2) that compare the magnitude and similarity of element values between elements having adjacent index information among the elements belonging to a specific group.

At this point, there may be a total of 8 patterns that comparator #0, comparator #1, and comparator #2 may output. (e.g., ‘Index 0, 1, 2’, ‘Index 0, 1, 3’, ‘Index 0, 2, 2’, ‘Index 0, 2, 3’, ‘Index 1, 1, 2’, ‘Index 1, 1, 3’, ‘Index 1, 2, 2’, ‘Index 1, 2, 3’)

Accordingly, the processor 120 may extract a valid element on the basis of multiplexers and additional comparators (e.g., comparator #3, comparator #4) that determine M/2 (e.g., 2) elements, which are as many as half of M (e.g., 4) elements included in each group, by using, as an input, a combination of any two elements among the elements output by the comparators (e.g., comparator #0, comparator #1, comparator #2) that compare the elements included in a specific group with the elements having adjacent index information, and generating a selection signal set in advance on the basis of a pattern determined among the 8 patterns.

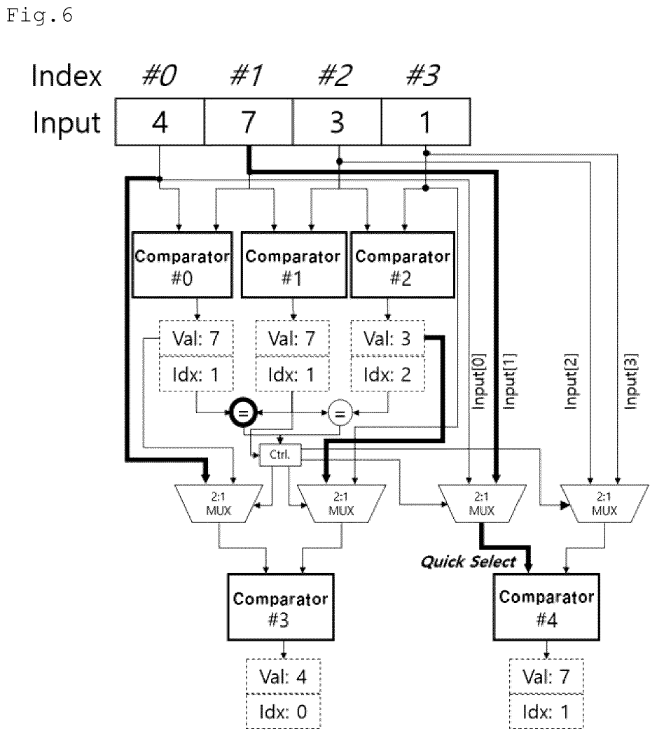

Hereinafter, the operation of the comparators and the multiplexers according to actual examples of the 8 patterns will be described with reference to FIGS. 6 to 13.

FIG. 6 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 1, 1, 2’.

Referring to FIG. 6, when elements [Input[0], Input[1], Input[2], Input[3]] of a specific group are input, pattern ‘index 1, 1, 2’means a pattern in which both comparator #0 and comparator #1 output Input[1] corresponding to index 1 as the maximum value, and comparator #2 outputs Input[2] corresponding to index 2.

In this case, Input[1] is determined as a first valid element representing the largest value in the group. In addition, in order to extract a second valid element, comparator #3 may determine a second largest value by comparing Input[0] and the output of comparator #2. At this point, the selection signal of the multiplexer may be set in advance so that the multiplexer may transfer Input[0], which is the output of comparator #0, and the output of comparator #2 to comparator #3. Accordingly, comparator #3 may determine the second valid element by selecting the larger value among Input[0] and the output of comparator #2.

Comparator #4 additionally confirms the relationship between the maximum value and the second valid element by performing a quick select algorithm on Input[1] and the other element value, and provides the result as a fixed output. This hardware configuration is designed to obtain two maximum values always through the outputs of comparator #3 and comparator #4, and through this, the apparatus 100 may extract two largest elements regardless of the order of the elements. As a result, in FIG. 6, as comparator #3 outputs Input[0] and comparator #4 outputs Input[1], the apparatus 100 may output two largest valid elements among the elements [Input[0], Input[1], Input[2], Input[3]].

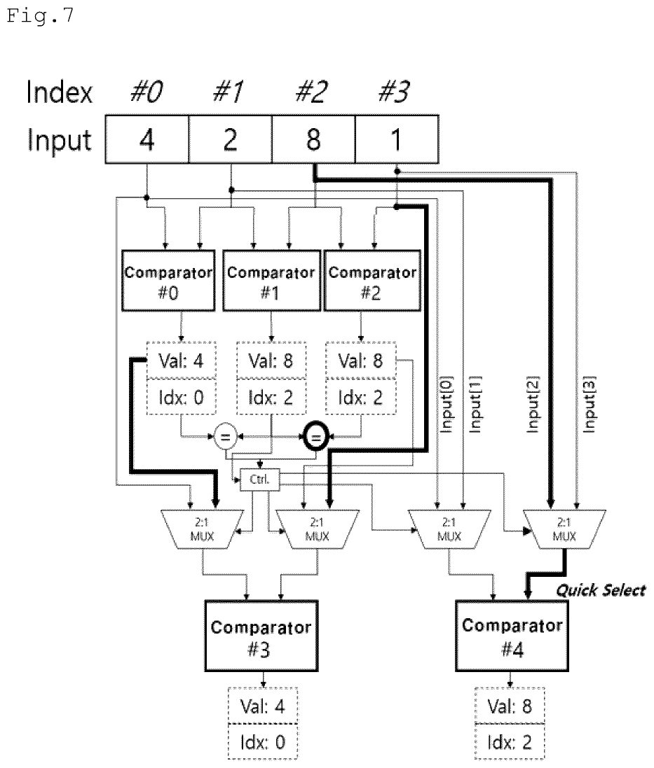

FIG. 7 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 0, 2, 2’.

Referring to FIG. 7, when elements [Input[0], Input[1], Input[2], Input[3]] of a specific group are input, pattern ‘index 0, 2, 2’means a pattern in which comparator #0 outputs Input[0] corresponding to index 0, and both comparator #1 and comparator #2 output Input[2] corresponding to index 2 as the maximum value.

In this case, Input[2] is determined as a first valid element representing the largest value in the group. Accordingly, in order to extract a second valid element, the process moves to a process of finding a second valid element among the remaining values [Input[0], Input[1], Input[3]] excluding Input[2].

Accordingly, comparator #3 compares result value Input[0] of comparator #0 and Input[3] and selects the larger value among them. At this point, the apparatus 100 controls the multiplexers through a selection signal so that comparator #3 extracts the second valid element. In addition, comparator #4 is set to receive Input[2] as an input and output Input[2] as it is through a quick select algorithm. This shows that the hardware is configured so that two maximum values are always obtained through the outputs of comparator #3 and comparator #4. As a result, in FIG. 7, as comparator #3 outputs Input[0] and comparator #4 outputs Input[2], the apparatus 100 may output two valid elements having the largest magnitudes among the elements [Input[0], Input[1], Input[2], Input[3]].

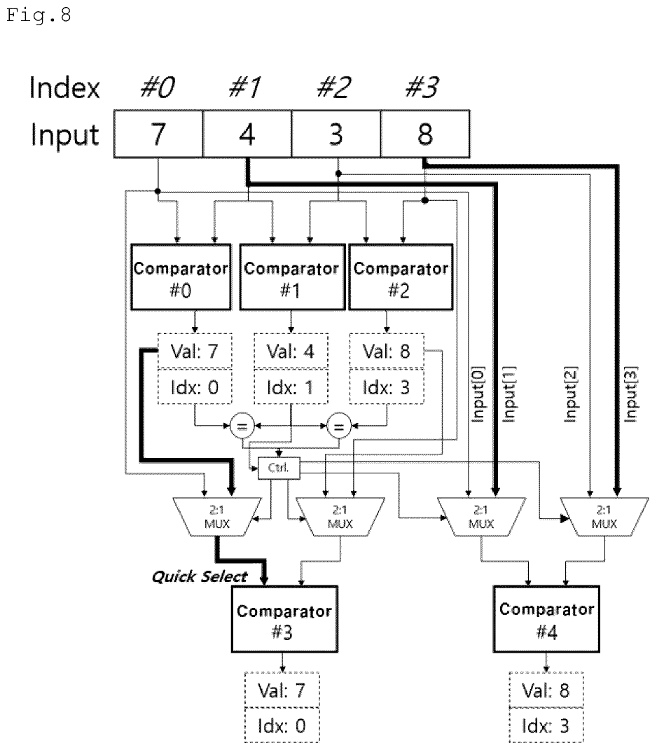

FIG. 8 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 0, 1, 3’.

Referring to FIG. 8, when elements [Input[0], Input[1], Input[2], Input[3]] of a specific group are input, pattern ‘index 0, 1, 3’ means a pattern in which comparator #0 outputs Input[0] corresponding to index 0, comparator #1 outputs Input[1] corresponding to index 1, and comparator #2 outputs Input[3] corresponding to index 3. This pattern indicates that Input[2] is the minimum value among the four input values in the initial comparison result, and in the steps thereafter, the process proceeds to a process of selecting two largest values among the remaining elements [Input[0], Input[1], Input[3]].

First, comparator #3 compares the result of comparator #0 and Input[3] and selects one among maximum values. At this point, since the multiplexer is set to preferentially refer to the result of comparator #0 through a selection signal, Input[0] is output as one of the maximum values. Meanwhile, comparator #4 compares Input[1] and Input[3] on the basis of the result of comparator #1 and selects a larger value. In this process, the multiplexer is controlled so that Input[3] is output as the second value among the maximum values. As a result, comparator #3 outputs Input[0] and comparator #4 outputs Input[3], so that valid elements Input[0] and Input[3] can be extracted.

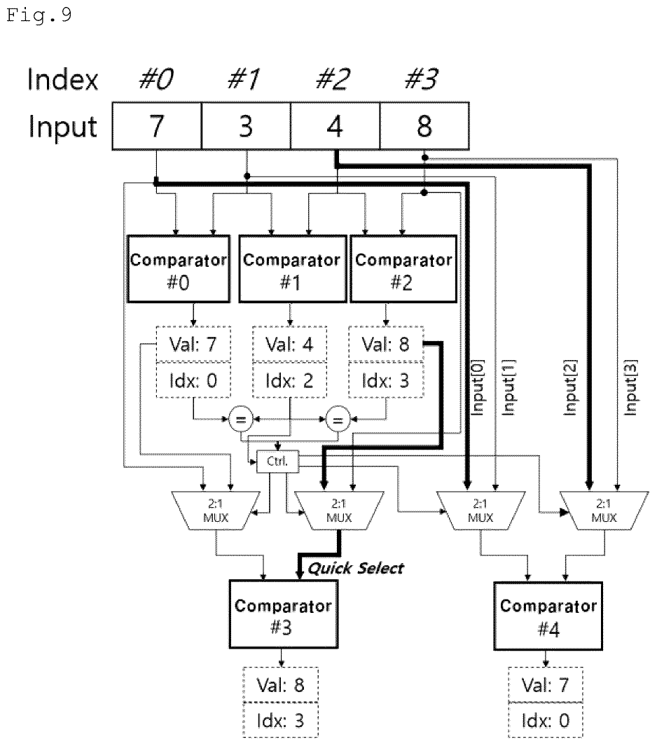

FIG. 9 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 0, 2, 2’.

Referring to FIG. 9, when elements [Input[0], Input[1], Input[2], Input[3]] of a specific group are input, pattern ‘index 0, 2, 3’ means a pattern in which comparator #0 outputs Input[0] corresponding to index 0, comparator #1 outputs Input[2] corresponding to index 2, and comparator #2 outputs Input[3] corresponding to index 3. This pattern indicates that Input[1] is the minimum value among the four input values, and in the steps thereafter, the process proceeds to a process of selecting two largest values among the remaining elements [Input[0], Input[2], Input[3]].

Comparator #3 selects Input[3] as one of maximum values through a quick select operation. Since Input[3] is a value selected as a maximum value in any case, the multiplexer is controlled to fix the output of comparator #3 to Input[3] according to a selection signal. Meanwhile, comparator #4 compares Input[0] and Input[2] and selects a larger value. In this process, it is set to control the multiplexer through a selection signal so that comparator #4 outputs Input[0]. As a result, comparator #3 outputs Input[3] and comparator #4 outputs Input[0], so that valid elements Input[0] and Input[3] can be extracted.

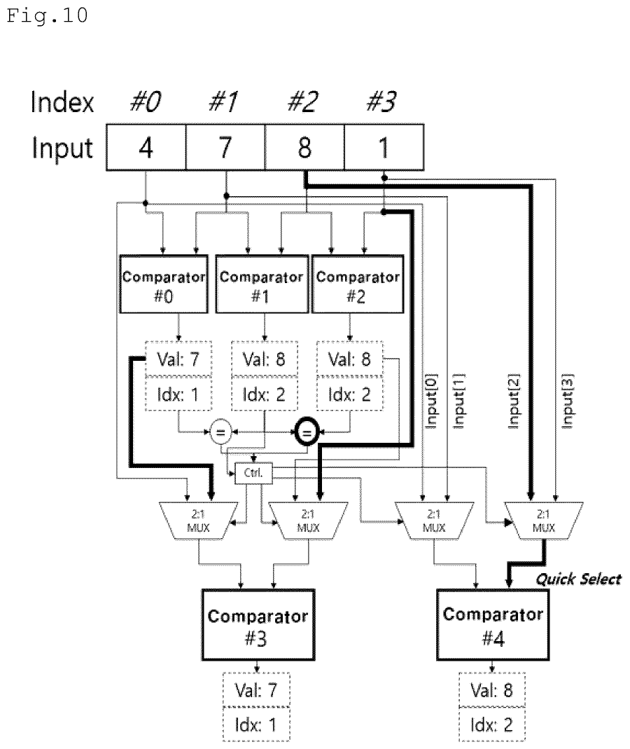

FIG. 10 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 1, 2, 2’.

Referring to FIG. 10, when elements [Input[0], Input[1], Input[2], Input[3]] of a specific group are input, the pattern ‘Index 1, 2, 2’ means a pattern in which comparator #0 outputs Input[1] corresponding to index 1, and both comparator #1 and comparator #2 output Input[2] corresponding to index 2. This indicates that Input[2] is the largest value, and this leads to a process of selecting this value as one of maximum values.

First, Input[2] is output as the maximum value through a quick select operation of comparator #4. This is since it is set to control the multiplexer through a selection signal so that comparator #4 always returns Input[2]. Comparator #3 is utilized to find a second largest value among the remaining values [Input[0], Input[1], Input[3]]. Based on the relationship Input[1]>Input[0], which is a result of comparator #0, comparator #3 compares Input[1] and Input[3] and outputs the larger value. As a result, comparator #3 selects Input[1] as the second largest value. Therefore, as comparator #3 outputs Input[1] and comparator #4 outputs Input[2] according to the pattern of FIG. 10, valid elements Input[1] and Input[2] can be extracted.

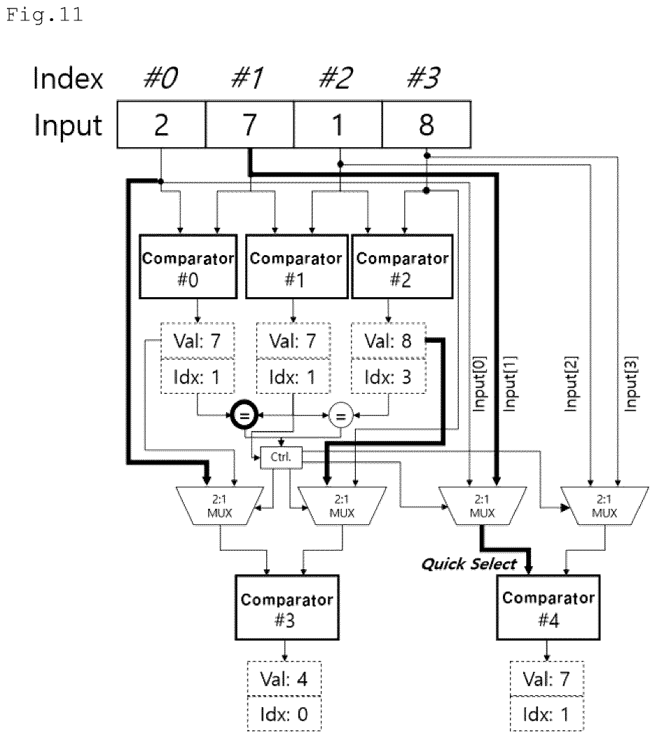

FIG. 11 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 1, 1, 3’.

Referring to FIG. 11, when elements [Input[0], Input[1], Input[2], Input[3]] of a specific group are input, pattern ‘index 1, 1, 3’ means a pattern in which both comparator #0 and comparator #1 output Input[1] corresponding to index 1, and comparator #2 outputs Input[3] corresponding to index 3. This corresponds to a case where Input[1] and Input[3] should be selected as a maximum value, and in this case, valid elements are determined by utilizing the output of the comparators and a selection signal.

First, comparator #3 outputs Input[1]. Since both comparator #0 and comparator #1 return Input[1] as a result, the multiplexer is set to select this result. Meanwhile, comparator #4 is configured to directly output Input[3] by performing a quick select operation. In this process, the selection signal controls the multiplexer to guarantee that comparator #4 returns Input[3]. Therefore, valid elements Input[1] and Input[3] can be extracted.

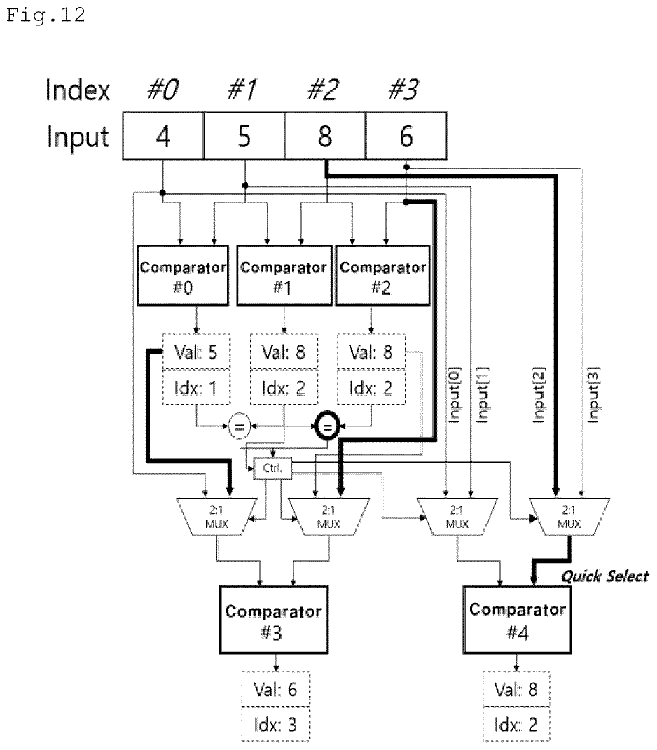

FIG. 12 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 1, 2, 2’.

Referring to FIG. 12, when elements [Input[0], Input[1], Input[2], Input[3]] of a specific group are input, pattern ‘index 1, 2, 2’ means a pattern in which comparator #0 outputs Input[1] corresponding to index 1, and both comparator #1 and comparator #2 output Input[2] corresponding to index 2. This indicates a situation in which Input[2] and Input[3] should be selected as maximum values, and in this case, valid elements are determined by utilizing the output of the comparators and a selection signal.

When Input[2]>Input[3] in this pattern, comparator #4 always outputs Input[2] through a quick select operation. It is set to control the multiplexer through a selection signal so that comparator #4 returns Input[2]. Meanwhile, comparator #3 directly outputs Input[3], which is the result of comparator #2. This follows the structure in which Input[3] is determined as the second value among the maximum values. As a result, comparator #3 outputs Input[3] and comparator #4 outputs Input[2], so that valid elements Input[2] and Input[3] can be extracted.

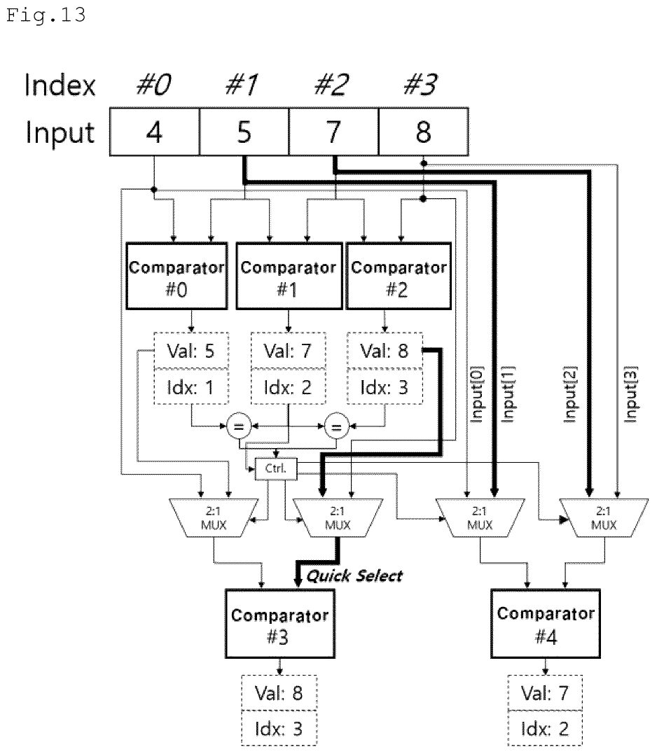

FIG. 13 is an exemplary view showing an operation of extracting valid elements by controlling multiplexers through a preset selection signal when the pattern of comparators that compare the magnitude of element values between elements having adjacent index information among the elements belonging to a specific group is a pattern of ‘index 1, 2, 2’.

Referring to FIG. 13, when elements [Input[0], Input[1], Input[2], Input[3]] of a specific group are input, pattern ‘index 1, 2, 3’ means a pattern in which comparator #0 outputs Input[1] corresponding to index 1, comparator #1 outputs Input[2] corresponding to index 2, and comparator #2 outputs Input[3] corresponding to index 3. This indicates a situation in which Input[2] and Input[3] should be selected as maximum values, and in this case, valid elements are determined by utilizing the output of the comparators and a selection signal.

When Input[2]<Input[3] in this pattern, Input[3] is always selected as a maximum value. Comparator #3 directly outputs Input[3] through a quick select operation, and it is set to control the multiplexer through a selection signal so that Input[3] is returned as one of maximum values. Meanwhile, Input[0] determined as the smallest value is excluded from the comparison, and comparison on the remaining values [Input[1], Input[2]] is performed by comparator #4. Comparator #4 compares Input[1] and Input[2] and outputs the larger value, and Input[2] is selected as a second maximum value as a result thereof. As a result, comparator #3 outputs Input[3], and comparator #4 outputs Input[2], so that valid elements Input[2] and Input[3] can be extracted.

Considering all the cases of FIGS. 6 to 13 described above, the selection signal of a multiplexer for selecting input values to be input into comparator #3 and comparator #4 may operate as described below.

First, when the results of comparator #0 and comparator #1 match, comparator #3 compares Input[0] with the result of comparator #2 and outputs a maximum value. At this point, comparator #4 outputs Input[1], which is a value always selected through a quick select operation, as a result.

Next, when the results of comparator #1 and comparator #2 match, comparator #3 compares the result of comparator #0 with Input[3] and outputs a maximum value, and comparator #4 outputs Input[2], which is a value always selected through a quick select operation, as a result.

Next, when the results of comparators #0, #1, and #2 do not match and the result of comparator #1 is Input[1], comparator #3 outputs Input[0] (the result of comparator #0), which is a value always selected through a quick select operation. At the same time, comparator #4 compares the result of comparator #1 (Input[1]) with the result of comparator #2 (Input[2] or Input[3]) and outputs a maximum value.

Next, when the results of comparators #0, #1, and #2 do not match and the result of comparator #1 is Input[2], comparator #3 outputs Input[3] (the result of comparator #2), which is a value always selected through a quick select operation. In this case, comparator #4 compares the result of comparator #0 (Input[0] or Input[1]) with the result of comparator #1 (Input[2]) and outputs a maximum value.

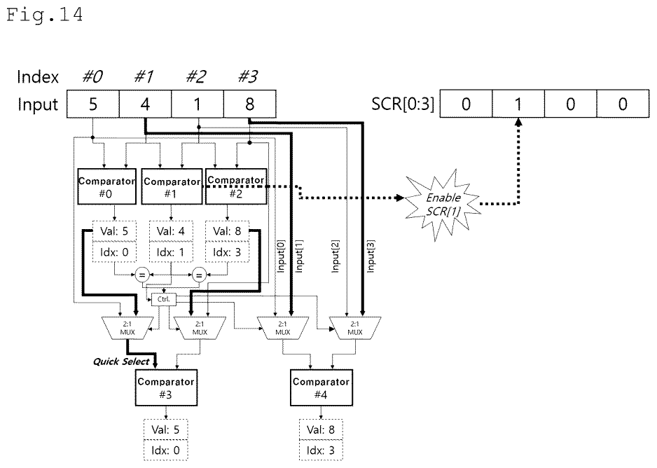

Hereinafter, an example of storing the value of the second register and utilizing the second register value will be described through an example of an actual value according to FIG. 14.

FIG. 14 is an exemplary view for explaining an operation of extracting two valid elements among four elements belonging to a specific group, and storing and utilizing similar elements that have not been extracted as valid elements in a second register.

Referring to FIG. 14, when element values [Input[0]=5, Input[1]=4, Input[2]=1, Input[3]=8] of a specific group are input, comparators #0, #1, and #2 compare the input values and derive a valid element, respectively, and finally, comparators #3 and #4 may extract Input[0] and Input[3] as a valid element, respectively. At this point, comparator #0 may determine Input[0] and Input[1], in which all bits except the LSB have the same value, as a pair of similar elements.

Therefore, according to the embodiments described above at step S1020, in order to reflect information on the similar element pair, the apparatus 100 may store ‘1’ as the value of SCR[1] corresponding to an order the same as that of Input[1] in the second register (e.g., SRC[0:3] of FIG. 14) having an index order the same as that of the elements included in the group according to the example of FIG. 14. Accordingly, when any one first element (e.g., Input[0]) among the similar element pairs included in a specific group corresponds to a valid element and a vector operation has been performed, the apparatus 100 may generate a third data by inserting a value the same as the element value of the first element on which the vector operation has been performed at the element value position of the other second element (e.g., Input[1]) on which the vector operation has not been performed, with reference to the similarity information (e.g., ‘1’ of SCR[1]) stored in the second register at step S1040.

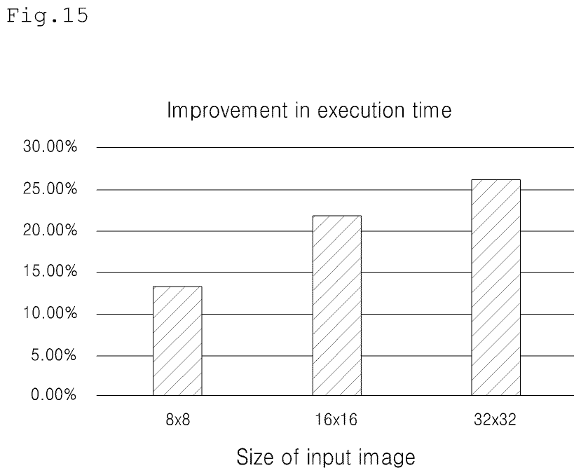

FIG. 15 is a performance graph showing the ratio of improvement in execution time by the size of input images by applying an embodiment of the present invention.

Referring to FIG. 15, when the input image size is 8×8, an improvement of about 10% in the execution time is observed, and when the image size increases to 16×16, the ratio of improvement in the execution time increases to about 20%, and at a larger size of 32×32, a ratio of improvement of about 25% or more is recorded. These results imply that when the embodiment of the present invention is applied, a higher efficiency is demonstrated as the size of input data increases.

According to the embodiments described above, the present invention provides a technique of simultaneously improving operation speed and energy efficiency by efficiently processing sparse data distribution in a mixed precision environment. In particular, the present invention reduces the overall amount of operation by reducing unnecessary operation through a structure that selectively processes only valid values among data transferred from the memory to the vector register, and realizes reduction in operation time and saves resources through this.

In addition, the present invention may maintain operation accuracy while reducing memory usage by applying a format conversion technique to optimize data transfer between the memory and operation units in a mixed precision environment. Through this, the overall processing efficiency can be increased in the learning and inference process of a deep learning model, and a basis for implementing a high-performance system suitable for large-scale data processing can be provided.

As the sparse data distribution, as well as deep learning operations, can be applied to various application fields and usefully utilized in battery-based devices and large-scale data processing systems where energy efficiency is important, the present invention may maximize utilization of various hardware and software resources.

It should be understood that various embodiments of this document and the terms used herein are not intended to limit the technical features described in this document to specific embodiments, but include various modifications, equivalents, or substitutes of the embodiments. In connection with the description of drawings, similar reference numerals may be used for similar or related components. The singular form of a noun corresponding to an item may include one or more items, unless the related context clearly indicates otherwise.

In this document, each of phrases such as “A or B”, “at least one among A and B”, “at least either A or B”, “A, B, or C”, “at least one among A, B, and C”, and “at least either A, B, or C” may include all possible combinations of the items listed together in a corresponding phrase among the phrases. Terms such as “1st”, “2nd”, “first”, or “second” may be used only to distinguish a corresponding component from another corresponding component, and do not limit the components in any other aspect (e.g., importance or order). When a certain (e.g., a first) component is referred to as being “coupled” or “connected” to another (e.g., a second) component with or without a term such as “functionally” or “communicatively”, it means that the component may be connected to another component directly (e.g., wired), wirelessly, or through a third component.

The term “module” used in this document may include a unit implemented in hardware, software, or firmware, and may be used interchangeably with terms such as logic, logic block, part, or circuit. A module may be an integrally configured component, or a minimum unit of a component or a portion thereof that performs one or more functions. For example, according to an embodiment, a module may be implemented in the form of an application-specific integrated circuit (ASIC).

Various embodiments of this document may be implemented as software (e.g., a program) including one or more instructions stored in a storage medium (e.g., a memory) that can be read by a device (e.g., an electronic device). The storage medium may include a random-access memory (RAM), a memory buffer, a hard drive, a database, an erasable programmable read-only memory (EPROM), an electrically erasable read-only memory (EEPROM), a read-only memory (ROM), and/or the like.

In addition, the processor in the embodiments of this document may call at least one command among one or more stored commands from the storage medium and execute the command. This allows the device to operate to perform at least one function according to the called at least one command. The one or more commands may include a code generated by a compiler or a code that can be executed by an interpreter. The processor may be a general-purpose processor, a Field Programmable Gate Array (FPGA), an Application Specific Integrated Circuit (ASIC), a Digital Signal Processor (DSP), and/or the like.

The storage medium that can be read by a device may be provided in the form of a non-transitory storage medium. Here, ‘non-transitory’ only means that the storage medium is a tangible device and does not include signals (e.g., electromagnetic waves), and this term does not distinguish the cases where data is stored semi-permanently on the storage medium from the cases where data is stored temporarily.

The method according to various embodiments disclosed in this document may be provided to be included in a computer program product. The computer program product may be traded between a seller and a buyer as goods. The computer program product may be distributed in the form of a machine-readable storage medium (e.g., a compact disc read only memory (CD-ROM)), or may be distributed online (e.g., downloaded or uploaded) through an application store (e.g., Play Store) or directly distributed between two user devices (e.g., smart phones). In the case of online distribution, at least a part of the computer program product may be at least temporarily stored in a machine-readable storage medium, such as a memory of a manufacturer's server, an application store's server, or a server, or may be temporarily generated.

According to various embodiments, each component (e.g., a module or a program) of the components described above may include a single or a plurality of entities. According to various embodiments, one or more of the components or operations of the components described above may be omitted, or one or more other components or operations may be added. Alternatively or additionally, a plurality of components (e.g., modules or a programs) may be integrated into a single component. In this case, the integrated component may perform one or more functions of each of the plurality of components in a way identical or similar to those performed by the corresponding component among the plurality of components before the integration. According to various embodiments, the operations performed by the modules, programs, or other components may be executed sequentially, in parallel, repeatedly, or heuristically, or one or more of the operations may be executed in a different order or omitted, or one or more other operations may be added.

The present invention provides a technique of simultaneously improving operation speed and energy efficiency by efficiently processing sparse data distribution in a mixed precision environment. In particular, the present invention reduces the overall amount of operation by reducing unnecessary operation through a structure that selectively processes only valid values among data transferred from the memory to the vector register, and realizes reduction in operation time and saves resources through this.

In addition, the present invention may maintain operation accuracy while reducing memory usage by applying a format conversion technique to optimize data transfer between the memory and operation units in a mixed precision environment. Through this, the overall processing efficiency can be increased in the learning and inference process of a deep learning model, and a basis for implementing a high-performance system suitable for large-scale data processing can be provided.

As the sparse data distribution, as well as deep learning operations, can be applied to various application fields and usefully utilized in battery-based devices and large-scale data processing systems where energy efficiency is important, the present invention may maximize utilization of various hardware and software resources.

Meanwhile, the effects of the present invention are not limited to those mentioned above, and unmentioned other technical effects will be clearly understood by those skilled in the art from the following descriptions.

### DESCRIPTION OF SYMBOLS

100: Apparatus
110: Memory
120: Processor
130: Input/Output Interface
140: Communication Interface

What is claimed is:

1. A method performed by a vector processor input/output control apparatus operated by a processor, the method comprising:
an operation of loading a first data configured of elements of N-bit format onto a lower memory corresponding to a vector register for performing a vector operation;
an operation of classifying the elements of the first data into one or more groups, and extracting a valid element corresponding to valid data from each group on the basis of magnitude and similarity of element values of the elements of each group;
an operation of loading a second data obtained by converting the valid element into an element of 2N-bit format onto the vector register, and performing a vector operation; and
an operation of converting a result of the vector operation into a third data configured of elements of N-bit format with reference to an index and similarity of the valid element, and storing the third data in the lower memory.

2. The method according to claim 1, wherein the operation of extracting a valid element includes an operation of classifying the elements into halves in order of indexes of the elements included in the first data, and creating two groups.

3. The method according to claim 2, wherein the operation of extracting a valid element includes an operation of determining an element having a larger element value according to preset criteria by one-to-one comparing the element values of the elements belonging to each group.

4. The method according to claim 3, wherein when both an element value of an element with index A and an element value of an element with index B are ‘0’ in determining an element having a larger element value among the element with index A and the element with index B (A is an index smaller than B), the operation of determining an element having a larger element value includes an operation of determining the element with index A the larger.

5. The method according to claim 3, wherein when one among two values of an element value of an element with index A and an element value of an element with index B is ‘0’ in determining an element having a larger element value among the element with index A and the element with index B (A is an index smaller than B), the operation of determining an element having a larger element value includes an operation of determining an element having a value other than ‘0’ the larger.

6. The method according to claim 3, wherein when both an element value of an element with index A and an element value of an element with index B are not ‘0’ in determining an element having a larger element value among the element with index A and the element with index B (A is an index smaller than B), the operation of determining an element having a larger element value includes an operation of determining an element having a larger value by comparing exponent bits and mantissa bits excluding a sign bit of a floating-point number of each element value.

7. The method according to claim 3, wherein the operation of extracting a valid element includes an operation of extracting valid elements as many as half of the number of elements belonging to each group, and storing index information of the extracted valid elements in a first register.

8. The method according to claim 7, wherein the operation of storing the third data in the lower memory includes an operation of generating the third data by inserting a value, which is obtained by converting a result of the vector operation performed on the valid element in an N-bit format, at a position of the element value of the index information extracted as a valid element among the elements of each group with reference to the first register.

9. The method according to claim 2, wherein the operation of extracting a valid element includes an operation of determining similar elements having similarity between element values according to preset criteria by comparing element values of elements having adjacent index information among the elements belonging to each group.

10. The method according to claim 9, wherein when it is determined that N−1 or more bits of the most significant bits (MSB), including a sign bit of an element value of an element with index A and an element value of an element with index B, among total N bits are the same in determining similarity between an element with index A and an element with index B (A is an index smaller than B) having adjacent index information, the operation of determining similar elements includes an operation of determining that the element with index A and the element with index B are similar.

11. The method according to claim 9, wherein the operation of extracting a valid element includes an operation of adding a bit flag to a similar element pair specifying the element with index A and the element with index B determined to have similarity, and storing the similar element pair in a second register.

12. The method according to claim 11, wherein when a first element, which is any one among the similar element pair included in each group, corresponds to a valid element and a vector operation is performed with reference to the second register, the operation of storing the third data in the lower memory includes an operation of generating the third data by inserting a value the same as an element value of the first element, on which a vector operation is performed, at a position of the element value of a second element, which is the other one on which the vector operation is not performed.

13. The method according to claim 1, wherein the operation of extracting a valid element includes an operation of comparing a magnitude and similarity of element values between elements on the basis of a comparator configured to receive two element values, output an element value of a larger magnitude, and output whether there is a similarity between the elements.

14. The method according to claim 13, wherein when the first data has 2M elements and each group has M elements, and a pattern is determined for a result of comparing magnitude values of elements having adjacent index information among the elements belonging to each group on the basis of M−1 comparators that compare the magnitude and similarity of element values between elements having adjacent index information among the elements belonging to each group, the operation of extracting a valid element includes an operation of extracting the valid element on the basis of multiplexers that determine M/2 elements, which are as many as half of M elements included in each group, by using a combination of any two elements among the elements included in each group as an input, and generating a selection signal set in advance on the basis of the pattern.

15. The method according to claim 14, wherein when both an element value of an element with index A and an element value of an element with index B are ‘0’ in determining an element having a larger element value among the element with index A and the element with index B (A is an index smaller than B), the comparator determines the element with index A the larger.

16. The method according to claim 14, wherein when one among two values of an element value of an element with index A and an element value of an element with index B is ‘0’ in determining an element having a larger element value among the element with index A and the element with index B (A is an index smaller than B), the comparator determines an element having a value other than ‘0’ the larger.

17. The method according to claim 14, wherein when both an element value of an element with index A and an element value of an element with index B are not ‘0’ in determining an element having a larger element value among the element with index A and the element with index B (A is an index smaller than B), the comparator determines an element having a larger value by comparing exponent bits and mantissa bits excluding a sign bit of a floating-point number of each element value.

18. The method according to claim 14, wherein when it is determined that N−1 or more bits of the most significant bits (MSB), including a sign bit of an element value of an element with index A and an element value of an element with index B, among total N bits are the same in determining similarity between an element with index A and an element with index B (A is an index smaller than B) having adjacent index information, the comparator determines that the element with index A and the element with index B are similar.

19. A vector processor input/output control apparatus comprising:
a memory containing instructions; and
a processor for performing a predetermined operation on the basis of the instructions, wherein
the operation of the processor includes:
an operation of loading a first data configured of elements of N-bit format onto a lower memory corresponding to a vector register for performing a vector operation;
an operation of classifying the elements of the first data into one or more groups, and extracting a valid element corresponding to valid data from each group on the basis of magnitude and similarity of element values of the elements of each group;
an operation of loading a second data obtained by converting the valid element into an element of 2N-bit format onto the vector register, and performing a vector operation; and
an operation of converting a result of the vector operation into a third data configured of elements of N-bit format with reference to an index and similarity of the valid element, and storing the third data in the lower memory.

20. A computer program stored in a non-transitory computer-readable recording medium and including instructions for performing, when the computer program is executed on at least one processor,
an operation of loading a first data configured of elements of N-bit format onto a lower memory corresponding to a vector register for performing a vector operation;
an operation of classifying the elements of the first data into one or more groups, and extracting a valid element corresponding to valid data from each group on the basis of magnitude and similarity of element values of the elements of each group;
an operation of loading a second data obtained by converting the valid element into an element of 2N-bit format onto the vector register, and performing a vector operation; and
an operation of converting a result of the vector operation into a third data configured of elements of N-bit format with reference to an index and similarity of the valid element, and storing the third data in the lower memory, performed by the processor.
